(19) United States
(12) Patent Application Publication
(10) Pub. No.: US 2011/0315160 A1
(43) Pub. Date: Dec. 29, 2011

(54) ORNAMENT AND HAIR ACCESSORY HAVING THE SAME

(76) Inventor: Ching-Pang LIAO, Tainan City (TW)

(21) Appl. No.: 12/855,355

(22) Filed: Aug. 12, 2010

(30) Foreign Application Priority Data
Jun. 29, 2010 (TW) 099212327

(51) Int. Cl. A45D 8/12; A45D 8/00; B32B 3/10

(52) U.S. Cl. 132/275; 428/195.1; 132/276

(57) ABSTRACT

An ornament includes a substrate, a reflective layer formed on the substrate and capable of bright reflection, and a printed pattern layer provided on the reflective layer. The printed pattern layer includes a transparent patterned region to reflect light therethrough, and a non-transparent shielding region that shields the reflective layer. The transparent patterned region is brightened by the reflective layer, and includes a plurality of spaced-apart transparent pattern elements distributed in the non-transparent shielding region.

### BACKGROUND OF THE INVENTION

1. Field of the Invention

This invention relates to an ornament, more particularly to an ornament made of plastic and a hair accessory having the same.

2. Description of the Related Art

To achieve a particular aesthetic appearance and glittering effect of an accessory, such as a hair accessory or brooch, artificial stones or crystals are inlaid on a surface of the accessory, and are arranged to form different designs or patterns. Prior to inlaying the stones, a pattern is first laid out on the surface of the accessory, after which holes are bored accordingly. The stones are then adhered one by one to the respective holes using glue, so that the surface of the accessory forms a glittering picture. However, because the stones are small, to form a large picture on the surface of an accessory, a large amount of stones must be adhered one by one to the surface of the accessory. This process is time consuming. Further, because the accessory is likely to bump onto something during use or storage thereof, and because the stones are adhered to the surface only by glue, after using the accessory for a period of time, the stones gradually fall off from the surface so that the picture on the surface of the accessory becomes incomplete, thereby adversely affecting the aesthetic appearance of the accessory. Thus, a conventional accessory with a glittering effect has a time consuming manufacturing process and stones that easily fall off and negatively affect the appearance of the accessory.

### SUMMARY OF THE INVENTION

Therefore, an object of the present invention is to provide an ornament and a hair accessory that have a glittering effect similar to that of artificial stones, that have a shortened manufacturing time, and that do not have inlaid objects which may likely to fall off.

According to one aspect of this invention, an ornament comprises a substrate, a reflective layer formed on the substrate and capable of bright reflection, and a printed pattern layer provided on the reflective layer and including a transparent patterned region to reflect light therethrough, and a non-transparent shielding region that shields the reflective layer. The transparent patterned region is brightened by the reflective layer.

According to another aspect of this invention, a hair accessory comprises a hair clip, and an ornament attached to the hair clip and including a substrate, a reflective layer formed on the substrate and capable of bright reflection, and a printed pattern layer provided on the reflective layer. The printed pattern layer includes a transparent patterned region that permits the reflective layer to reflect light therethrough, and a non-transparent shielding region that shields the reflective layer. The transparent patterned region has a plurality of spaced-apart transparent spots distributed in the non-transparent shielding region and brightened by the reflective layer.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a hair accessory according to the first preferred embodiment of the present invention;

FIG. 2 is an exploded schematic view of an ornament of the hair accessory of the first preferred embodiment;

FIG. 3 is a fragmentary sectional view of the ornament of the first preferred embodiment; and

FIG. 4 is a schematic top view of a hair accessory according to the second preferred embodiment of the present invention.

### DETAILED DESCRIPTION OF THE PREFERRED EMBODIMENTS

The above-mentioned and other technical contents, features, and effects of this invention will be clearly presented from the following detailed description of two preferred embodiments in coordination with the reference drawings.

Before this invention is described in detail, it should be noted that, in the following description, similar elements are designated by the same reference numerals.

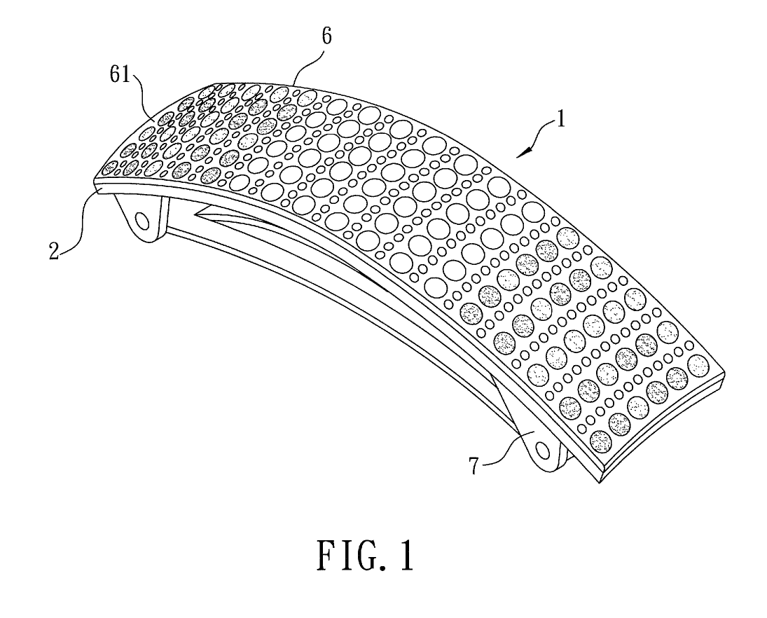

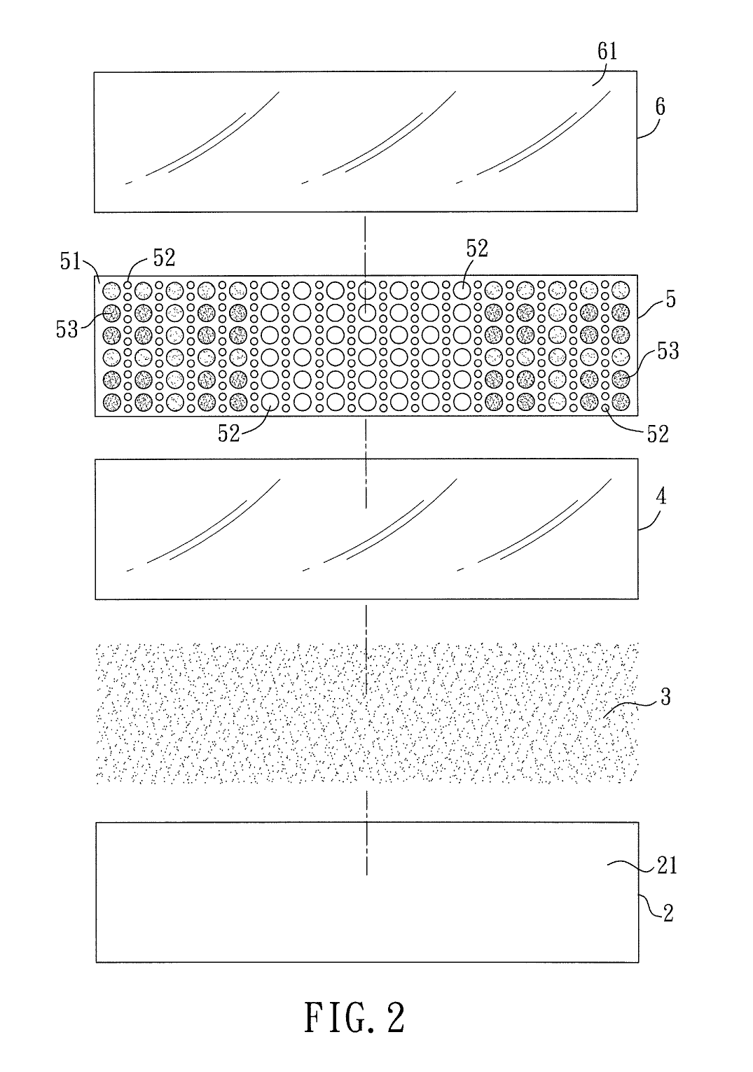

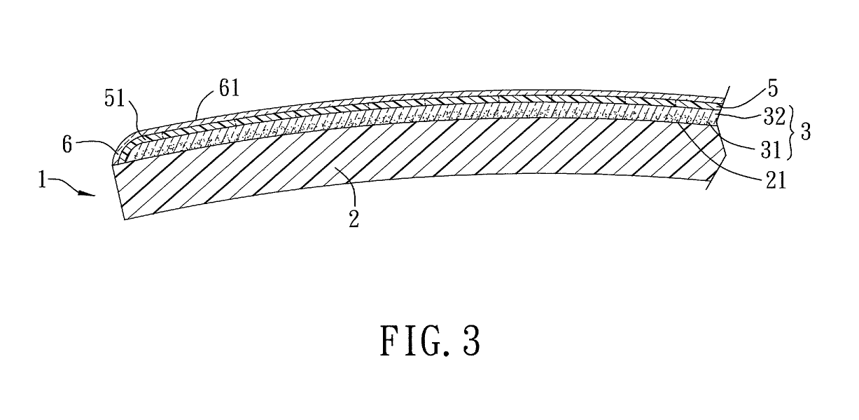

Referring to FIGS. 1 to 3, a hair accessory according to the first preferred embodiment of the present invention is shown to comprise a hair clip 7 and an ornament 1.

The ornament 1 is connected to the hair clip 7, and includes a substrate 2, a reflective layer 3, a printed pattern layer 5, and a protective coating layer 6. In this embodiment, the substrate 2 is curved, is made of a non-transparent plastic material, and is black in color. The substrate 2 has a connecting surface 21 that faces upwardly. Alternatively, the substrate 2 may have any other shape, and is not limited to the aforesaid curved shape.

The reflective layer 3 is capable of bright reflection, and covers the connecting surface 21 of the substrate 2. The reflective layer 3 may be a reflective coating layer that includes a transparent coating 32 and glitter particles 31. The transparent coating 32 may be made from a curable resin composition that may include an acrylic resin and a hardener. The reflective layer 3 may be formed by mixing the glitter particles 31 with the curable resin composition and by applying the resulting mixture to the connecting surface 21 of the substrate 2. During the process of curing the curable resin composition, the glitter particles 31 can precipitate and gather on the connecting surface 21. Accordingly, the glitter particles 31 are embedded in a portion of the transparent coating 32 proximate to the connecting surface 21 of the substrate 2.

However, the reflective layer 3 should not be limited only to the reflective coating layer containing the transparent coating 32 and the glitter particles 31. Any other reflective material that has bright reflection characteristics may be used in the present invention. For example, a reflective sheet capable of bright reflection may be adhered to the connecting surface 21, and a transparent coating may be applied to the reflective sheet.

The printed pattern layer 5 is provided on and covers the reflective layer 3 by ink printing. The printed pattern layer 5 includes a transparent patterned region and a non-transparent shielding region 51. The transparent patterned region includes a plurality of spaced-apart transparent pattern elements 52, 53 distributed in the non-transparent shielding region 51. The transparent pattern elements include transparent colored pattern elements 53 and transparent colorless pattern elements 52. The colorless and colored pattern elements 52, 53, in this embodiment, are configured as circular spots, and are arranged in alternating rows. Each colored pattern element 53 has a predetermined color. The color of each colored pattern element 53 is not limited to one color, and may be a combination of different colors. Further, in this embodiment, the colorless pattern elements 52 have two sizes. Each of the colorless and colored pattern elements 52, 53 may have any desirable shape and size, and is not limited to the aforesaid disclosures. It is worth mentioning that the printed pattern layer 5 may only include the shielding region 51 and the transparent colorless pattern elements 52 or the shielding region 51 and the transparent colored pattern elements 53.

The protective coating layer 6 is colorless and transparent, and is used for covering and protecting the printed pattern layer 5. The protective coating layer 6 has a buffed surface 61, so that the surface of the ornament 1 reflects light well.

As light passes through the transparent protective coating layer 6 and the colorless and colored pattern elements 52, 53 of the printed pattern layer 5, it is reflected through the reflective layer 3. The reflected light from the reflective layer 3 passes through the colorless and colored pattern elements 52, 53, and out of the buffed surface 61 of the protective coating layer 6. A portion of the reflected light passes through the transparent colorless pattern elements 52 to emit white light, and another portion of the reflected light passes through the transparent colored pattern elements 53 to emit different colors of light. The remaining portion of the reflected light is shielded by the shielding region 51, so that the contours of light emitting from the colorless and colored pattern elements 52, 53 are clear and definite. Hence, the ornament 1 produces a plurality of light reflecting points. Moreover, because the reflective layer 3 includes the glitter particles 31, light is reflected in different directions from the positions of the glitter particles 31. Hence, a reflection effect of the ornament 1 simulates a reflection from a cutting face of a diamond.

From the aforesaid description, it is apparent that the ornament 1 of the present invention is provided with the reflective layer 3 that includes the glitter particles 31 embedded within the acrylic transparent coating 32, and further with the printed pattern layer 5 defining the transparent colorless and colored pattern elements 52, 53 of different sizes. The hair accessory of the present invention therefore forms a glittering effect similar to that of artificial stones, but without adhering or inlaying any stones. Further, the ornament 1 of the hair accessory of the present invention has a reduced processing time and no risk that any stones will fall off.

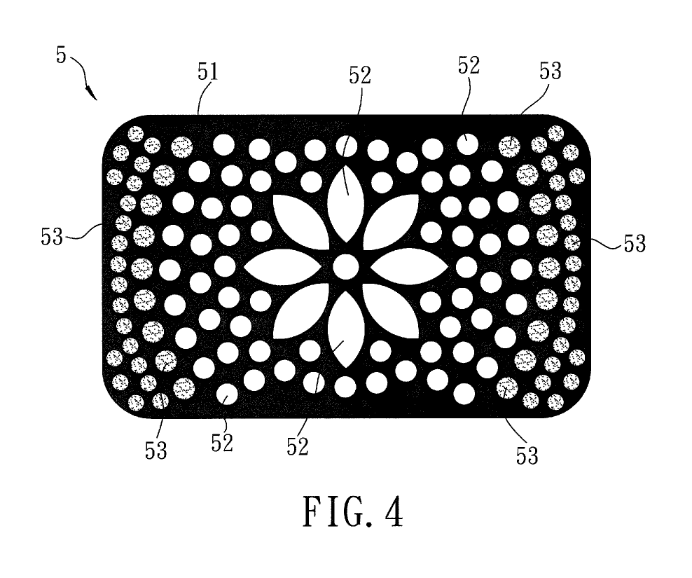

Referring to FIG. 4, a hair accessory according to the second preferred embodiment of the present invention is shown to be similar to the first preferred embodiment. However, in this embodiment, the transparent colorless pattern elements 52 of the printed pattern layer 5 are configured as circular spots and petal-like spots. The transparent colorless pattern elements 52 that have petal-like spots are disposed on a central portion of the non-transparent shielding region 51, and are arranged angularly spaced apart from each other to form the pattern of a flower. The transparent colorless pattern elements 52 that have circular spots are spaced apart from each other to surround the flower pattern. The transparent colored pattern elements 53 are disposed on two opposite sides of the non-transparent shielding region 51, and are configured as circular spots having different sizes. The colorless pattern elements 52 are disposed between the colored pattern elements 53. Each transparent colored pattern element 53 may be any transparent pale color, such as light yellow, pink, or light blue. Hence, the hair accessory of the present invention, aside from achieving a reflection effect similar to that of a diamond, the shapes and sizes of the transparent colorless and colored pattern elements 52, 53 and the color of the colored pattern elements 53 may also be altered, so that the ornament 1 of the hair accessory of the present invention may be produced with a special design. Hence, the ornament 1 of the hair accessory of the present invention has many interesting variations.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

I claim:

1. An ornament comprising:
a substrate;
a reflective layer formed on said substrate and capable of bright reflection; and
a printed pattern layer provided on said reflective layer, and including a transparent patterned region that permits said reflective layer to reflect light therethrough, and a non-transparent shielding region that shields said reflective layer, wherein said transparent patterned region is brightened by said reflective layer.

2. The ornament of claim 1, wherein said transparent patterned region includes a plurality of spaced-apart transparent pattern elements distributed in said non-transparent shielding region.

3. The ornament of claim 2, wherein said transparent pattern elements include transparent colored pattern elements and transparent colorless pattern elements.

4. The ornament of claim 2, wherein said transparent pattern elements are configured as spots.

5. The ornament of claim 1, further comprising a transparent protective coating layer covering said printed pattern layer.

6. The ornament of claim 5, wherein said transparent protective coating layer has a buffed surface.

7. The ornament of claim 1, wherein said substrate is made of a non-transparent plastic material.

8. The ornament of claim 1, wherein said reflective layer is a reflective coating layer that includes a transparent coating and glitter particles.

9. The ornament of claim 1, wherein said reflective layer includes a reflective sheet attached to said substrate.

10. A hair accessory comprising:
a hair clip, and
an ornament attached to said hair clip and including
a substrate;
a reflective layer formed on said substrate and capable of bright reflection; and
a printed pattern layer provided on said reflective layer, and including a transparent patterned region that permits said reflective layer to reflect light therethrough, and a non-transparent shielding region that shields said reflective layer, said transparent patterned region having a plurality of spaced-apart transparent spots distributed in said non-transparent shielding region and brightened by said reflective layer.

11. The ornament of claim 10, wherein said reflective layer is a reflective coating layer that includes a transparent coating and glitter particles.
